(19) United States
(12) Patent Application Publication
(10) Pub. No.: US 2006/0232274 A1
(43) Pub. Date: Oct. 19, 2006

(54) Nuclear quadrupole resonance inspection system

(76) Inventors: Gareth Nigel Shilstone, Kent (GB); John Michael Bradley, Kent (GB); Richard Ian Jenkinson, Kent (GB)

Correspondence Address: JOHN S. PRATT, ESQ;KILPATRICK STOCKTON, LLP, 1100 PEACHTREE STREET, ATLANTA, GA, 30309, US

(21) Appl. No.: 10/559,371

(22) PCT Filed: May 20, 2004
(86) PCT No.: PCT/GB04/02182

§ 371 Date: May 8, 2006

(30) Foreign Application Priority Data
Jun. 6, 2003 (GB) 0312986.3

(51) Int. Cl. G01V 3/00

(52) U.S. Cl. 324/322; 324/318; 324/307; 324/300

(57) ABSTRACT

A multi-resonant nuclear quadrupole resonance (NQR) inspection system is disclosed. The system comprises a multi-resonant circuit 16 tuned to simultaneously transmit and receive a plurality of signals. The receiver circuit comprises passive circuit protection in the form of a lumped element quarter-wave unit 10 and a signal generator 6 and frequency mixer 8 are used to modify the return signals in order to facilitate signal monitoring. The system has been shown to simultaneously detect RDX and PETN.

This invention relates to the field of nuclear quadrupole resonance inspection systems and particularly to a multi-resonant system for simultaneously detecting the presence of a plurality of target materials.

Interaction of the electric quadrupole moment of a nucleus with the electric field gradient around the nucleus causes the magnetic nuclear energy levels to split. Nuclear quadrupole resonance (NQR) occurs when a resonant radio frequency (RF) field is applied to excite transitions between such energy levels. NQR inspection is a technique for probing transitions between the split energy levels, which are excited by resonant RF fields, to produce RF spectra, thereby enabling detection of a range of materials. However, only those nuclei having a spin quantum number I greater than ½, such as ¹⁴N and ³⁵CI, possess an electric quadrupole moment and, hence, display a NQR response. Characteristic transitions between energy levels occur at frequencies that are unique to a particular material because the quadrupole interaction is sensitive to the position of the quadrupolar nucleus within a molecule and also the crystalline structure of the substance. Therefore NQR can be used for the potentially unambiguous identification of a compound containing quadrupolar nuclei. Application of signal processing and thresholding of the return signal means that the detection process can be fully automated with little need for operator training. This gives NQR detection the potential of high probability of detection with low false alarm rates for a known target material.

It is known to use NQR inspection, for example, at airports to detect the presence of substances such as narcotics, pharmaceuticals or explosives in baggage, although in principle, NQR could be used to detect the presence of any material incorporating quadrupolar nuclei.

Conventionally radio frequency (RF) pulses, at the specific resonance frequency for the material of interest, are applied to the sample to be inspected. If the material of interest is present transitions between the energy levels are excited, and during relaxation the corresponding return signal can be detected. However, other materials, which may also be of interest, will be missed because the NQR device is not timed to detect them. In other words, the high specificity of sample detection, which provides the desired low false alarm rates, means that the use of NQR as a generic detector is not currently possible. In order to detect different materials an optimised transmitter/receiver is required for each frequency. In practice this requires fast electronic and mechanical switching to re-tune the device or, more likely, a separate device tuned for each frequency.

Simultaneous detection of a plurality of materials using a single NQR device, without the need for electronic or mechanical switching, would make the deployment of NQR inspection systems more attractive for a variety of applications.

It is an object of this invention to provide a multi-resonant NQR inspection system for simultaneously detecting the presence of a plurality of target materials.

Accordingly this invention provides a nuclear quadrupole resonance (NQR) inspection system for simultaneously detecting the presence of a plurality of target materials comprising transmission means for applying a pulsed radio frequency signal to a sample and a receiver circuit for receiving the return signal wherein the transmission means and receiver circuit comprise a multi-resonant circuit tuned to simultaneously transmit and receive a plurality of signals at a plurality of predetermined frequencies which frequencies substantially match characteristic resonant frequencies of a plurality of target materials and the receiver circuit further comprises passive circuit protection means to permit simultaneous reception of a plurality of return signals.

It is the combination of the multi-resonant probe with the passive circuit protection which enables the invention to function. Active circuit protection i.e. switching produces “ringing” which masks some of the signal thereby reducing the sensitivity of the system. In order to maintain sensitivity comparable to a singly tuned device it is necessary to minimise losses in the circuit by selecting high quality components and optimising the circuit design.

The system advantageously comprises a spectrometer capable of operating at a plurality of frequencies within a single pulse sequence. The spectrometer may have a single channel or multiple channels.

The receiver circuit preferably includes signal processing means adapted to modify widely separated return signals so that they can be monitored simultaneously by the spectrometer. The signal processing means may comprise a signal generator which, in use, produces a phase coherent mixing signal of predetermined frequency to bring the plurality of return signals within the maximum bandwidth of the spectrometer.

The passive circuit protection means preferably comprises a lumped element quarter-wave unit tuned to provide protection of the receiver circuit during signal transmission whilst allowing the plurality of return signals to be received. This acts as a low pass filter for low voltage signals and blocks high voltage signals at all frequencies. It therefore provides passive protection i.e. without the need for electronic switching, thereby maximising sensitivity.

There are several designs that will produce a multi-resonant circuit. These include interleaved sample coils, series tuned coils and tapped coils, where a connection is made to the sample coil at an intermediate point along it's length, effectively separating the single coil into two inductors.

The plurality of transmitted signals is ideally applied to excite target materials in such a way that the plurality of return signals can be received simultaneously. If a multiple channel spectrometer is used the signals may be transmitted as separate simultaneous signals. However, if a single channel spectrometer is used it will be necessary to interleave the transmitted signals so that pulses of one frequency are applied during the coil ringdown times arising from pulses applied at another frequency.

One desirable application for NQR inspection would be for generic explosive detection. There would be significant benefit in being able to simultaneously detect the presence of cyclotrimethylene trinitramine (RDX) and pentaerythritol tetranitrate (PETN) which are found in several plastic compositions, for example PE-4 and Detasheet respectively. These two materials are also found as a mixture, of variable ratio, in the plastic explosive Semtex. In common with many explosives, RDX and PETN contain nitrogen and since they are solid state compounds this leads to the possibility of performing ¹⁴N NQR on these materials. The three ring-¹⁴N nuclei in RDX are inequivalent in the solid state giving nine possible transitions. The room temperature frequencies of these transitions are 5.239 MHz; 5.190 MHz; 5.044 MHz; 3.458 MHz; 3.410 MHz; 3.359 MHz; 1.781 MHz (2 transitions); 1.685 MHz. There are also nine other transitions possible, arising from the three nitro-¹⁴N nuclei, but these have much lower frequencies and are not considered here. The molecular symmetry of PETN in the solid state gives rise to three possible transitions. The room temperature frequencies arising from the nitrate-¹⁴N nuclei are 0.890 MHz; 0.495 MHz; 0.395 MHz.

An important property of these transitions is their temperature dependence, which has implications for practical applications of this technique. Although the sensitivity of the technique increases with frequency it may be more appropriate to monitor a transition with a lower frequency. For example in the case of RDX, the 3.41 MHz transition has a temperature dependence (≈−100 Hz K⁻¹), which is one fifth that of the 5.19 MHz transition. It will be appreciated that where a room temperature resonant frequency is specified the transmitted frequency would in fact require adjustment to allow for the temperature dependency.

The type of pulse sequence that is used for excitation is dependent on the relaxation parameters (and in practical applications, the efficacy in rejecting spurious responses). For materials with a long spin lattice relaxation time (T₁), such as PETN, a pulsed spin locking (PSL) pulse sequence—a pulse train preceded with a preparation pulse where the phase of the train pulses differs by 90° with respect to the phase of preparation pulse—might be appropriate. For materials with a short T₁, such as RDX, a steady state free precession (SSFP) pulse sequence—a train of equally spaced pulses of equal length—might be appropriate. However, it will be understood that different types of pulse sequence could equally be selected.

The NQR inspection system may transmit a steady state free precession pulse sequence at 3.410 MHz interleaved with a pulsed spin locking pulse sequence at 0.890 MHz for the simultaneous detection of RDX and PETN. These frequencies assume room temperature conditions but should be adjusted for higher or lower ambient temperatures.

The invention will now be described, by way of example, with reference to the accompanying drawings, in which:

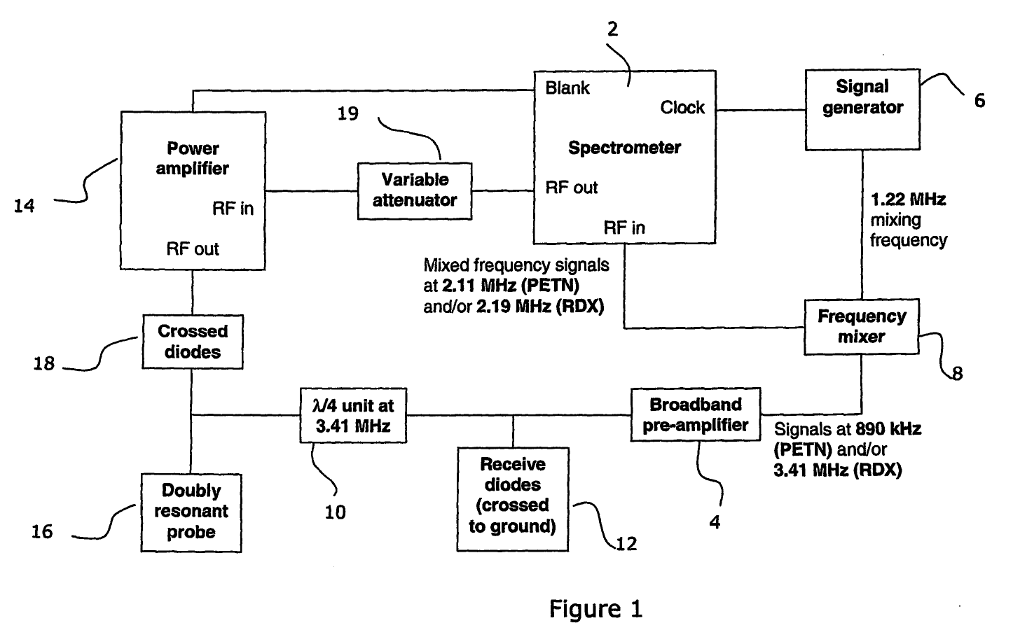

FIG. 1 is a schematic diagram of the inspection system according to the invention;

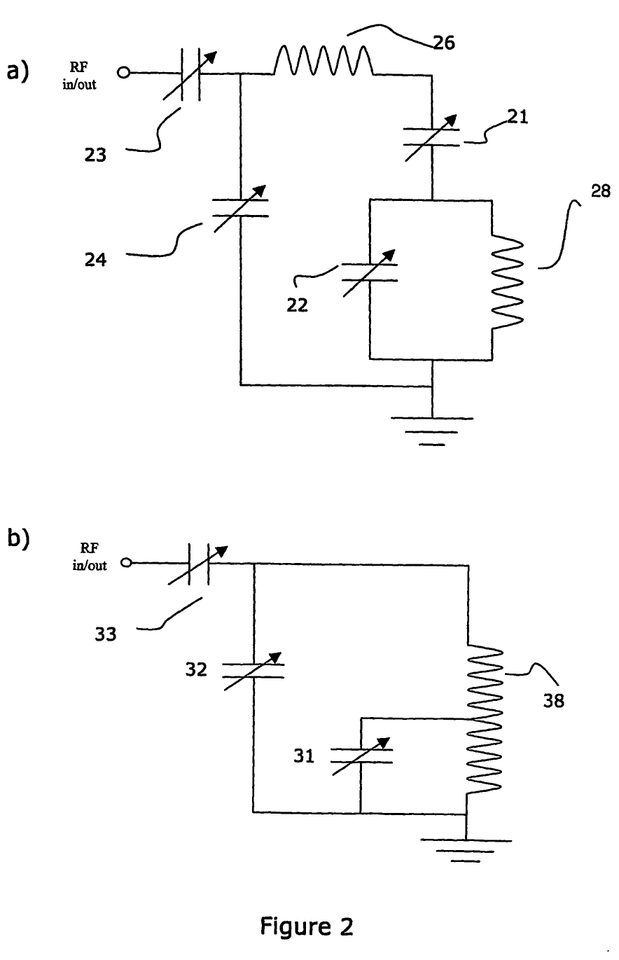

FIG. 2 provides schematic diagrams of two alternative doubly resonant circuits suitable for use according to the invention;

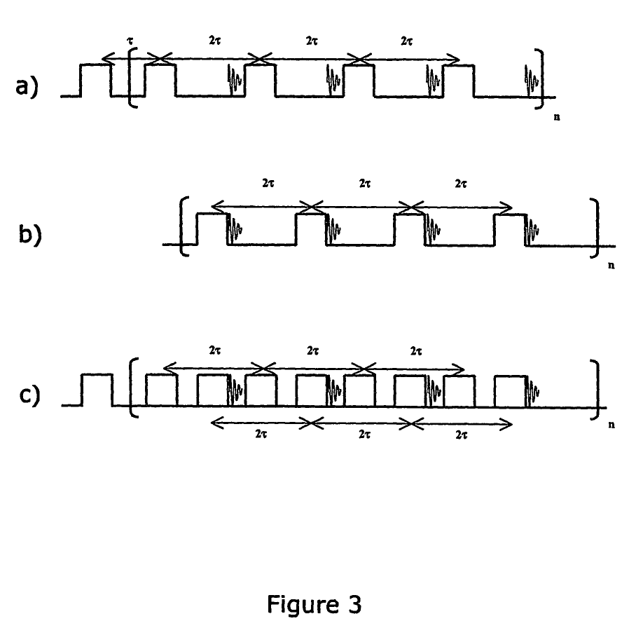

FIG. 3 illustrates an interleaved pulse sequence for use with the invention; and

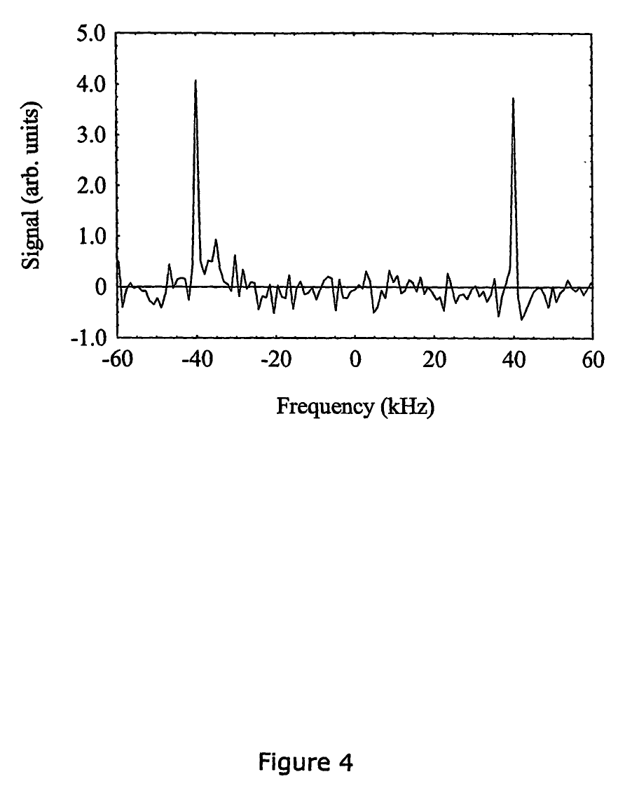

FIG. 4 shows the NQR spectrum for Semtex when excited with the interleaved pulse sequence of FIG. 3c.

With reference to FIG. 1, an embodiment of a multi-resonant NQR inspection system includes a single channel spectrometer (Apollo LF0.5-10 MHz from Tecmag Inc., Houston, USA) 2 which is controlled via a PC (NTNMR control software shipped with Apollo spectrometer). The NTNMR software includes a graphical editor that provides the environment for fast development of pulse sequences.

To bring the signals within the same audio band of the spectrometer 2 the pre-amplifier 4 output is mixed with a signal generator (PTS 040) 6 output of the appropriate frequency. The signal generator clock is provided externally by the 10 MHz clock output of the Apollo spectrometer 2. The frequency mixer 8 used is a Mini-Circuits ZAD-6 mixer.

Receiver protection is provided by inserting a quarter-wave lumped, equivalent circuit 10 and crossed diodes to ground 12 immediately before the pre-amplifier 4. A quarter-wave lumped, equivalent circuit has the property of being a low pass filter for low voltage signals (in addition to blocking high voltage signals at all frequencies). Therefore a quarter-wave element tuned to 3.41 MHz can be used to allow reception of both RDX and PETN signals. Pre-amplification of the NQR signal before the spectrometer receiver input is via a commercial pre-amplifier (Miteq AU—1464—8276, 0.4—-200 MHz) 4. Transmitter pulses to the probe 16 are amplified using a commercial broadband power amplifier (Kalmus LA100HP—CE, 100 W, 50 dB) 14 with a gating input for pulsed operation.

Variable attenuator 19 is used to vary the voltage of the transmitted signal to the power amplifier 14 and to ensure that the probe 16 is not overloaded. Crossed diodes 18 operate in transmit mode to remove high voltage noise and in receive mode to isolate the power amplifier 14 from the return signal.

In this embodiment the transmission means comprises spectrometer 2, variable attenuator 19, power amplifier 14, crossed diodes 18 and doubly resonant probe 16. The receiver circuit comprises doubly resonant probe 16, crossed diodes 18, quarter-wave lumped equivalent circuit 10, crossed diodes 12, pre-amplifier 4, spectrometer 2 and the signal processing means which comprises signal generator 6 and frequency mixer 8.

FIG. 2a shows a schematic circuit diagram of one embodiment of a doubly resonant probe 16. The probe comprises a sample coil 28, a secondary inductor 26 and variable capacitors 21-24 to generate the desired resonant frequencies. The secondary inductor 26 is hand wound and incorporates an air core rather than a ferrite core to reduce signal loss. Tuning and matching the sample coil 28 to the required frequency and impedance (50Ω) can be performed using an impedance gain phase analyser (HP 4194A) by adjustment of the variable capacitors 21-24. With care it is possible to simultaneously match the impedance at the probe input/output to 49Ω at both 0.89 MHz and 3.41 MHz. The quality factor (Q) at each tuned frequency was determined from the power response curve measured on a network analyser (HP 8752C) from Q=ν₀/Δν_{(3 dB)}, where ν₀ is the tuned frequency and Δν_{(3 dB)} is the bandwidth measured at the half-power points on the response curve. The Q at 0.89 MHz was found to be 75 and the Q at 3.41 MHz was found to be 65, where the doubly tuned probe was deliberately made more sensitive at 0.89 MHz to compensate to some degree for the intrinsically lower sensitivity at this frequency. Thus the sensitivity achieved simultaneously at each frequency compares favourably with that typically achieved for corresponding singly resonant probes at these frequencies, i.e. Q in the range of 60-90 for solenoids of similar dimensions and where we have used similar materials and components. The dimensions of the solenoid coil 28 that contains the sample are:

| | |
|---|---|
| Diameter | 53 mm |
| Length | 70 mm |
| Wire diameter | 1.25 mm (18 standard gauge) |
| Number of turns | 49 |
| Spacing of turns | No gap between adjacent turns |

FIG. 2b shows a schematic circuit diagram of an alternative embodiment of a doubly resonant probe 16. The probe comprises a tapped coil design, which can produce a doubly resonant circuit with only 3 capacitors 31-33 and a single inductor 38. The sample coil 38 is wound as two separate inductors, which are then connected in series to form one inductor with a tap point This enables measurement of the inductance of each coil to be made. It was found that both resonant frequencies could be matched to 50Ω when the values of the two sample coil inductors were equal. In this case, the sample coil consisted of two coils, each with an inductance of approximately 25 μH.

In practice it was found that both probe designs were capable of detecting RDX and PETN simultaneously.

The type of pulse sequence that is used for excitation is dependent on the relaxation parameters (and in practical applications, the efficacy in rejecting spurious responses). For PETN, which has a long T₁, a pulsed spin locking (PSL) pulse sequence—a pulse train preceded with a preparation pulse where the phase of the train pulses differs by 90° with respect to the phase of preparation pulse—was selected. If the pulse spacing within the pulse train is 2τ, then the pulse spacing between the preparation pulse and the first pulse in the pulse train is equal to τ. The pulse length of the preparation pulse is chosen to be an effective-90° and the pulse length of the train pulses is typically either effective-90° or effective-180°. The PSL sequence is shown in FIG. 3a. For RDX, which has a short T₁, a steady state free precession (SSFP) pulse sequence—a train of equally spaced pulses of equal length—was selected. The SSFP sequence is shown in FIG. 3b. The timings and phase cycling for the interleaved PSL/SSFP pulse sequence used is as follows:

PSL pulse lengths: preparation =160 μs, train=200 μs

SSFP pulse lengths: preparation=N/A, train=400 μs

2τ=2 ms

τ=1 ms

PSL phase cycling: Tx [+X, (+Y)ₙ|−X(+Y)ₙ]
Rx [(+X)ₙ|(−X)ₙ]

SSFP phase cycling: Tx [(+X)ₙ|(−X)ₙ|(+X)ₙ]
Rx [(+X)ₙ|(−X)ₙ|(−x)ₙ|(+X)ₙ]

For the PSL sequence we also implemented a ‘reverse-phase’pulse after each of the excitation pulses in the train. In this way we were able to reduce the dead time at 0.89 MHz (dead time∝1/frequency), thereby decreasing the pulse spacing, with a subsequent increase in the rate of signal acquisition for each substance. The pulse amplitude at each frequency was adjusted to give the following excitation fields: 215 μT at 3.41 MHz and 650 μT at 0.89 MHz. The pulse lengths for both materials were determined experimentally using the above excitation fields.

The interleaved PSL sequence at 0.89 MHz and SSFP sequence at 3.41 MHz which were used to detect PETN and RDX is shown in FIG. 3c.

FIG. 4 shows the room temperature NQR spectrum for Semtex, when excited with the interleaved sequence illustrated in FIG. 3c. The NQR signals due to ¹⁴N are clearly seen in each case, where the intermediate mixing frequency (1.22 MHz) has been deliberately chosen so that the RDX line and the PETN line appear offset from the spectrometer demodulation frequency (2.15 MHz) by +40 kHz and −40 kHz respectively. The actual frequencies of the RDX and PETN lines are 3.41 MHz and 0.89 MHz respectively, which correspond to the room temperature resonant frequencies as described previously. The choice of offset frequency was somewhat arbitrary but was made sufficiently large for the two lines to be well separated.

Although, the embodiment described concerns the simultaneous detection of RDX and PETN, the person skilled in the art will appreciate that the invention is equally applicable to other pairs of substances, such as heroin and cocaine. Furthermore, the invention can be applied to more than two resonances by carefully tuning a multi-resonant circuit and developing a suitable pulse sequence.

1. A nuclear quadrupole resonance (NQR) inspection system for simultaneously detecting the presence of a plurality of target materials comprising transmission means for applying a pulsed radio frequency signal to a sample and a receiver circuit for receiving the return signal wherein the transmission means and receiver circuit comprise a multi-resonant circuit tuned to simultaneously transmit and receive a plurality of signals at a plurality of predetermined frequencies which frequencies substantially match characteristic resonant frequencies of a plurality of target materials and the receiver circuit further comprises passive circuit protection means to permit simultaneous reception of a plurality of return signals.

2. A NQR inspection system according to claim 1 comprising a spectrometer capable of operating at a plurality of frequencies within a single pulse sequence.

3. A NQR inspection system according to claim 2 wherein the receiver circuit further comprises signal processing means adapted to modify a plurality of return signals so that they can be monitored simultaneously by the spectrometer.

4. A NQR inspection system according to claim 3 wherein the signal processing means comprises a signal generator which, in use, produces a phase coherent mixing signal of predetermined frequency to bring the plurality of return signals within the maximum bandwidth of the spectrometer.

5. A NQR inspection system according to claim 1 wherein the passive circuit protection means comprises a lumped element quarter-wave unit tuned to provide protection of the receiver circuit during signal transmission whilst allowing the plurality of return signals to be received.

6. A NQR inspection system according to claim 1 wherein the multi-resonant circuit comprises a tapped coil.

7. A NQR inspection system according to claim 1 wherein the plurality of transmitted signals is applied to excite target materials in such a way that the plurality of return signals can be received simultaneously.

8. A NQR inspection system according to claim 7 wherein the plurality of transmitted signals is interleaved.

9. A NQR inspection system according to claim 1 wherein the transmission means applies a steady state free precession pulse sequence at one of the characteristic resonance frequencies of RDX.

10. A NQR inspection system according to claim 1 wherein the transmission means applies a pulsed spin locking pulse sequence at one of the characteristic resonance frequencies of PETN.

11. A NQR inspection system according to claim 1 wherein the plurality of transmitted signals comprises a steady state free precession pulse sequence at 3.410 MHz interleaved with a pulsed spin locking pulse sequence at 0.890 MHz for the simultaneous detection of RDX and PETN.

12. (canceled)
